(19) United States
(12) Patent Application Publication
(10) Pub. No.: US 2012/0067941 A1
(43) Pub. Date: Mar. 22, 2012

(54) TUNER STRUCTURE SOLDERING METHOD FOR IMPROVING VOLTAGE DIFFERENCE

(75) Inventor: JACK T.P. LIU, NEW TAIPEI CITY (TW)

(73) Assignee: MUSTANG INDUSTRIAL CORP., NEW TAIPEI CITY (TW)

(21) Appl. No.: 13/304,492

(22) Filed: Nov. 25, 2011

Related U.S. Application Data
(63) Continuation-in-part of application No. 12/292,295, filed on Nov. 17, 2008, now abandoned.

(51) Int. Cl. B23K 1/20

(52) U.S. Cl. 228/244

(57) ABSTRACT

A tuner structure soldering method for improving voltage difference, comprising the following steps: preparing the tuner structure, wherein the tuner structure comprises a frame and a communication connector with a fitting portion preinstalled on the frame; putting a tin ring around the fitting portion;

melting the tin ring; permeating the melted tin ring into the gap between the through hole on the frame and the fitting portion of communication connector.

### CROSS-REFERENCE TO RELATED APPLICATION

This U.S. Non-provisional Application for Patent is a continuation-in-part (CIP) application of patent application Ser. No. 12/292,295 filed on Nov. 17, 2008, currently pending. The entirety of the above-mentioned patent application is hereby incorporated by reference herein and made as a part of this specification.

### BACKGROUND OF THE INVENTION

1. Field of the Invention

The present invention relates to a method for improving the voltage difference; in particular, the present invention relates to a tuner structure soldering method so as to reduce the drawback of voltage difference of the tuner structure.

2. Description of Related Art

A tuner structure comprises a communication connector and a frame (or named as tuner, can, RF can, RF shielding can, RF shielding frame, or lower cover) which are conventionally assembled by staking. Because the communication connector and the frame are independently formed, there is a tiny gap on the contacting surface when the communication connector and the frame are assembled. Therefore, the voltage difference could be generated due to increase of electromagnetic interference (EMI).

Conventionally, the voltage difference is improved by manually soldering the gap between communication connector and the frame (RF can). A worker needs to use both hands to respectively hold the tin wire and the soldering iron, so as to melt the tin to fill up the gap between the connector and the frame.

However, the manual soldering method has the following drawbacks.

1. More manpower is needed in traditional manual soldering. Output is low and average labor cost is high.

2. When manual soldering operation is performed, the worker needs to rotate the object to change the soldering direction and location, the required soldering time and manpower is further prolonged.

3. Fake-soldering may occur due to the human factor of careless operation, inferior skill, insufficiently preheat on object, and/or other causes.

4. Due to improper manual operation, over heating on object may occur and it will damage the plating layer of the communication connector and the frame.

5. Due to worker operation mistake, it is easy to make the soldering material be stained on the connection pin of the communication connector. Thereby noise may be generated or short-circuit may occur.

6. Due to worker operation mistake, it is easy to make soldering flux be carbonized to affect the appearance. Moreover, the carbonized material may flake off to cause other electronic components be short-circuited.

### SUMMARY OF THE INVENTION

The primary object of the present invention is to prevent the drawback for manual soldering, and reducing soldering time for the tuner structure.

To achieve the foregoing and the other objects, a tuner structure soldering method for improving voltage difference is provided. The soldering method comprises the following steps: preparing the tuner structure, wherein the tuner structure comprises a frame and a communication connector preinstalled on the frame by a fitting portion; putting a tin ring around the fitting portion; melting the tin ring; permeating the melted tin ring into the gap between the fitting portion of the communication connector and the mounting hole of the frame.

One of the embodiments according to the tuner structure soldering method, wherein the communication connector is preinstalled in a mounting hole of the frame and the fitting portion has the same cross section as the mounting hole.

One of the embodiments according to the tuner structure soldering method, wherein the ting ring contacts side wall of the frame or contact face of the frame.

One of the embodiments according to the tuner structure soldering method, wherein the frame has a first contact face, a second contact face, a mounting through hole on the frame, and a side wall joining the first contact face and the second contact face; wherein the first contact face and the second contact face are opposite to each other, and the first contact face is parallel to the second contact face.

One of the embodiments according to the tuner structure soldering method, wherein the melted tin ring completely encompass the side wall.

The present invention has the following characteristics and advantages:

1. The conductivity and the voltage difference of the communication connector and the frame are improved.

2. The manufacturing time is reduced to lower the manufacturing cost.

For further understanding of the present invention, reference is made to the following detailed descriptions illustrating the embodiments and examples of the present invention. The descriptions are for illustrative purpose only and should not be intended to limit the scope of the claim

### BRIEF DESCRIPTION OF THE DRAWINGS

The drawings included herein provide a further understanding of the present invention. A brief introduction of the drawings is as follows:

FIG. 1 is a schematic diagram of a tuner structure for improving the voltage difference according to the 1^{st} embodiment of the present invention before assembled;

FIG. 2 is a schematic diagram of the tuner structure for improving the voltage difference according to the 1^{st} embodiment of the present invention after assembled;

FIG. 3 is a schematic diagram of the tuner structure for improving the voltage difference according to the 2^{nd} embodiment of the present invention before assembled;

FIG. 4 is a schematic diagram of the tuner structure for improving the voltage difference according to the 2^{nd} embodiment of the present invention after assembled;

FIG. 5 is a schematic diagram of the tuner structure for improving the voltage difference according to the 3^{rd} embodiment of the present invention before assembled;

FIG. 6 is a schematic diagram of the tuner structure for improving the voltage difference according to the 3^{rd} embodiment of the present invention after assembled;

FIG. 7 is a schematic diagram of the tuner structure for improving the voltage difference according to the 4^{th} embodiment of the present invention before assembled;

FIG. 8 is a schematic diagram of the tuner structure for improving the voltage difference according to the 4^{th} embodiment of the present invention after assembled;

FIG. 9 is a schematic diagram of the tuner structure for improving the voltage difference according to the 5^{th} embodiment of the present invention before assembled;

FIG. 10 is a schematic diagram of the tuner structure for improving the voltage difference according to the 5^{th} embodiment of the present invention after assembled;

FIG. 11 is a schematic diagram of the tuner structure for improving the voltage difference according to the 6^{th} embodiment of the present invention after assembled;

FIG. 12 is a schematic diagram of the tuner structure for improving the voltage difference according to the 7^{th} embodiment of the present invention after assembled;

FIG. 13 is a schematic diagram of the tuner structure for improving the voltage difference according to the 8^{th} embodiment of the present invention after assembled;

FIG. 14 is a schematic diagram of the tuner structure for improving the voltage difference according to the 9^{th} embodiment of the present invention after assembled;

FIG. 15 is a schematic diagram of the tuner structure for improving the voltage difference according to the 10^{th} embodiment of the present invention after assembled;

FIG. 16 is a schematic diagram of the tuner structure for improving the voltage difference according to the 11^{th} embodiment of the present invention after assembled;

FIG. 17 is a schematic diagram of the tuner structure for improving the voltage difference according to the 12^{th} embodiment of the present invention after assembled;

FIG. 18 is a schematic diagram of the tuner structure for improving the voltage difference according to the 13^{th} embodiment of the present invention after assembled;

FIG. 19 is a schematic diagram of the tuner structure for improving the voltage difference according to the 14^{th} embodiment of the present invention after assembled;

FIG. 20 is a schematic diagram of the tuner structure for improving the voltage difference according to the 15^{th} embodiment of the present invention after assembled;

FIGS. 21A-21G are schematic diagrams respectively of a conducting element of the present invention. FIG. 22A-22B are schematic diagrams of the tuner structure for improving the voltage difference according to the 16^{th} embodiment of the present invention before assembled;

FIG. 23A-24B are schematic diagrams of the tuner structure for improving the voltage difference according to the 16^{th} embodiment of the present invention when the tin ring is assembled;

FIG. 25 is flow chart of the tuner structure soldering method according to the present invention.

### DETAILED DESCRIPTION OF PREFERRED EMBODIMENTS

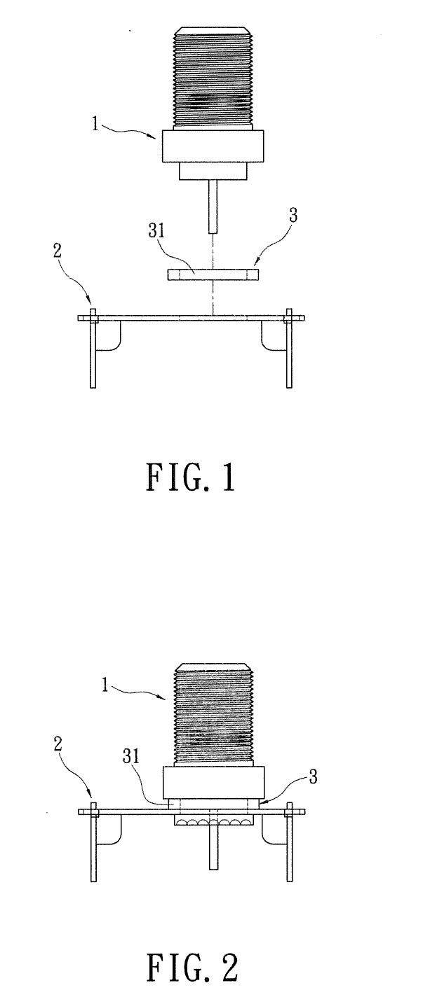

Reference is made to FIGS. 1-4. The tuner structure for improving the voltage difference of a connector of the present invention includes a communication connector 1, a frame 2, and a conducting element 3. The type of the communication connector 1 is not limited to a specific one. The communication connector 1 can be an F connector manufactured by turning or free-cutting, a PAL connector manufactured by turning, free-cutting, pipe-cutting, or deep-drawing, or other connector. The frame 2 is a metallic frame. The frame 2 is assembled with communication connector 1.

The conducting element 3 is a conductive metal or material, such as copper, aluminum, tin, iron, tin-strip, conducting gasket, or conductive glue, etc. In this embodiment, the conductive element 3 is a non-sticky conductive gasket 31. The conductive gasket 31 is a conductive metal or material and is non-sticky. The shape of the raw material can be flake-shaped, strip-shaped, board-shaped, roll-shaped, etc. The raw material is formed into a conductive gasket 31 by using a forming tool (traditional, airing, or pressuring), a slide forming or a rolling-knife punching tool. and a forming mold.

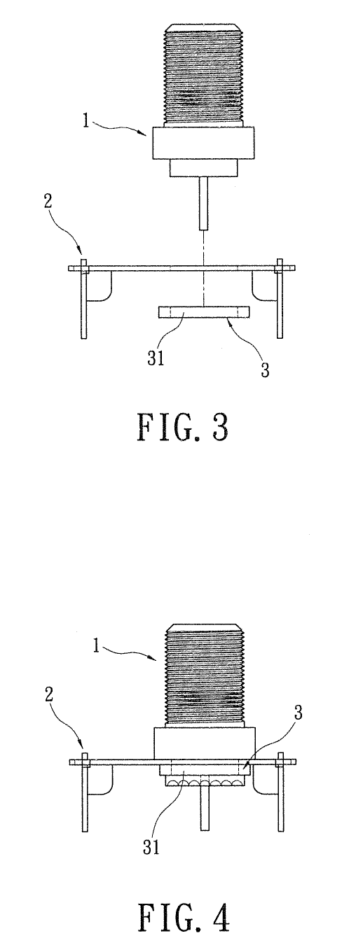

The conducting gasket 31 is located and conducted at the connection area of the communication connector 1 and the frame 2. Furthermore, the conducting gasket 31 can be installed at the outer side of the frame 2 (as shown in FIGS. 1 and 2), or the inner side of the frame 2 (as shown in FIGS. 3 and 4) depending on the requirements and the efficiency.

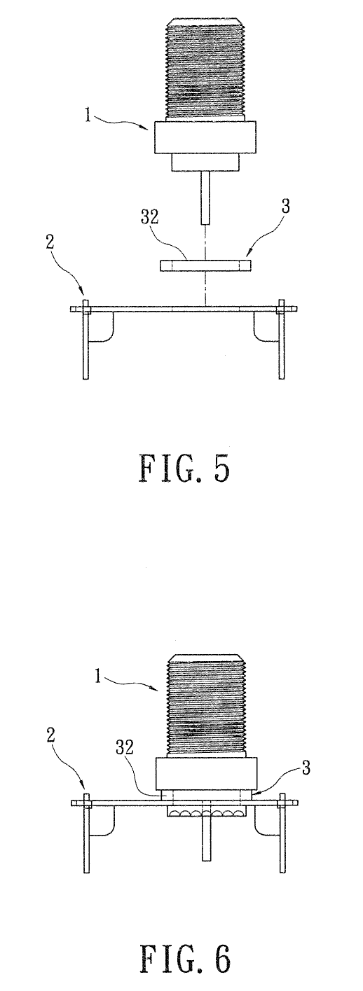

Reference is made to FIGS. 5 and 6. In this embodiment, the conducting element 3 is a non-sticky conducting gasket 32. The conducting gasket 32 is a conductive metal or material, is formed by an injection way with a metal or with a plastic injection mold and equipment. The conducting gasket 32 is located and conducted at the connection area of the communication connector 1 and the frame 2. Furthermore, the conducting gasket 32 can be installed at the outer side of the frame 2 (as shown in FIGS. 5 and 6), or the inner side of the frame 2 depending on the requirements and the efficiency.

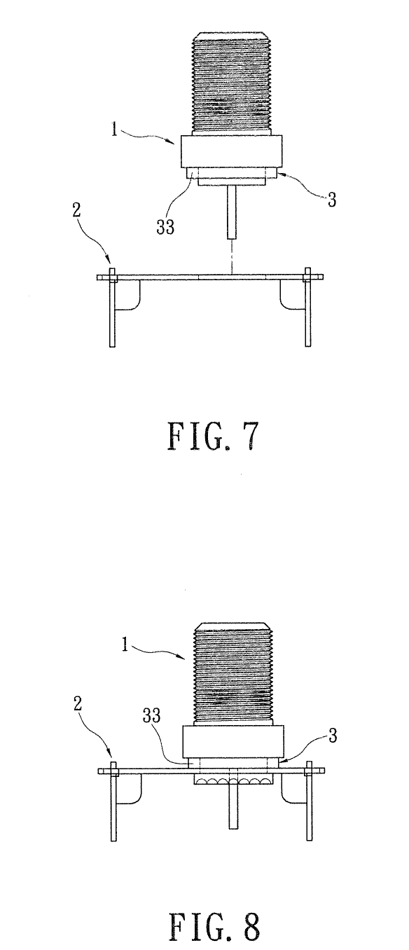

Reference is made to FIGS. 7 and 8. In this embodiment, the conducting element 3 is a sticky conducting gasket 33. The conductive gasket 33 is a conductive metal or material and is sticky. The shape of the raw material can be flake-shaped, strip-shaped, board-shaped, roll-shaped, etc. The raw material is formed into a conductive gasket 33 by using a forming tool (traditional, airing, or pressuring), a slide forming or a rolling-knife punching tool, and a forming mold.

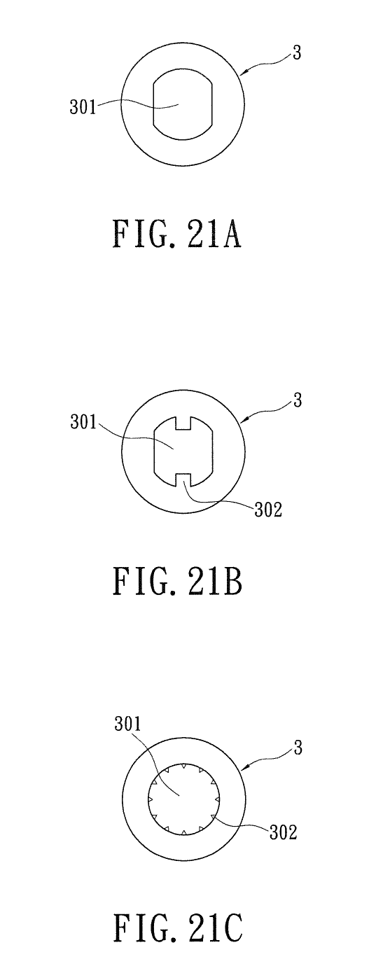

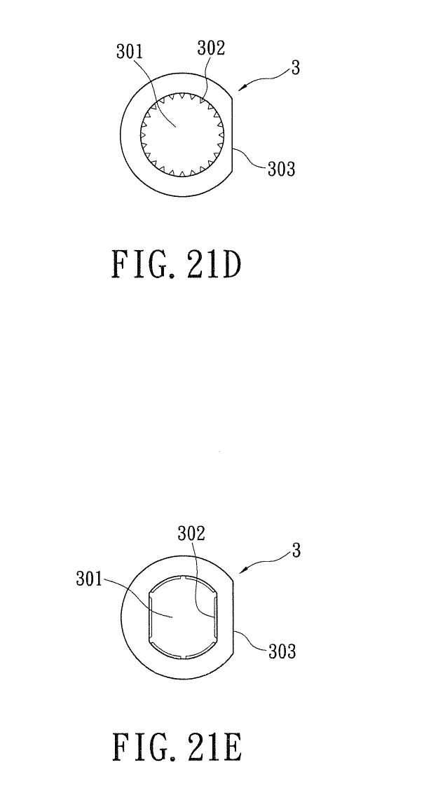

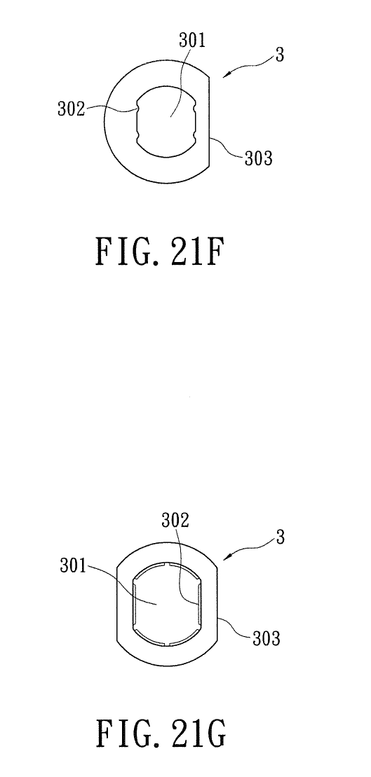

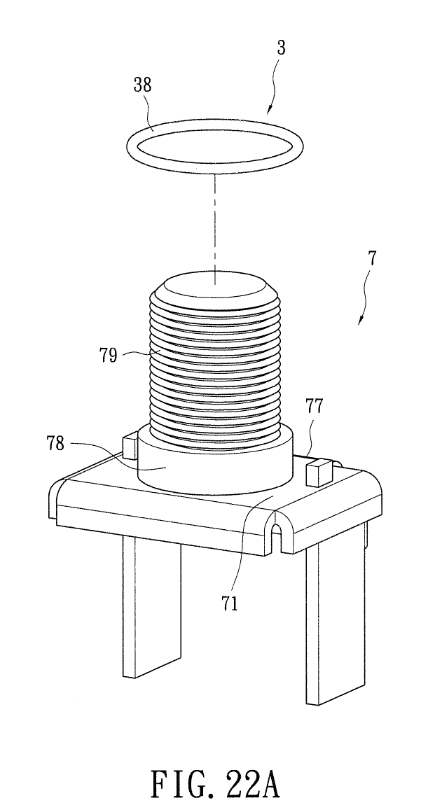

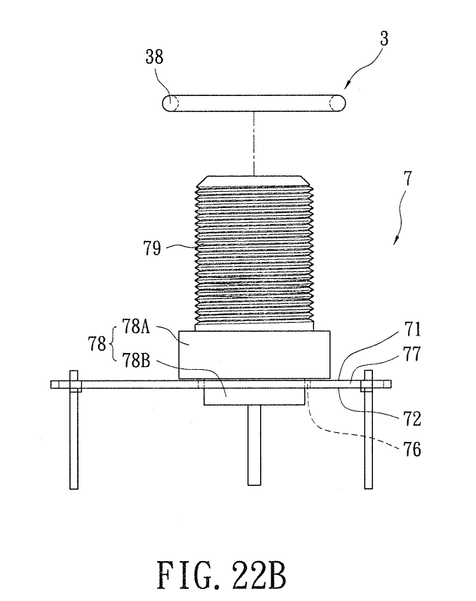

Firstly, the sticky conducting gasket 33 is pasted on the contacting location of the communication connector 1 or the frame 2, such as on the inner side, outer side of the frame 2, or on the communication 1 (as shown in FIGS. 7 and 8). Next, the communication connector 1 and the frame 2 are assembled so that the conducting gasket 33 is located and conducted at the connection area of the communication connector 1 and the frame 2. Reference is made to FIGS. 21A-21G. In this embodiment. the conducting element 3 (such as conducting gasket) has a through hole 301, and used for being sleeved onto the communication connector 1. At the through hole 301 of the conducting element 3, a convex structure 302 is formed by the punching, bending, or drawing way to improve the assembling process, and compensating the gap between the outer diameter of the communication connector 1 and the hole of the frame 2. Thereby, the contact area of the communication connector 1 and the frame 2 is increased to improve the conductivity and lower the voltage difference. The tiny convex, bent, and drawing structure that has been respectively formed by the punching, bending, and drawing way also has the positioning function to make the assembly process be easier and improve the production efficiency. However, the main function of the convex structure 302 is to increase the contact area of the communication connector 1 and the frame 2, especially to increase the contact area of the communication connector 1 and the hole of the frame 2. The conducting element 3 also has a positioning portion 303 for positioning the conducting element 3 onto the communication connector 1 or the frame 2.

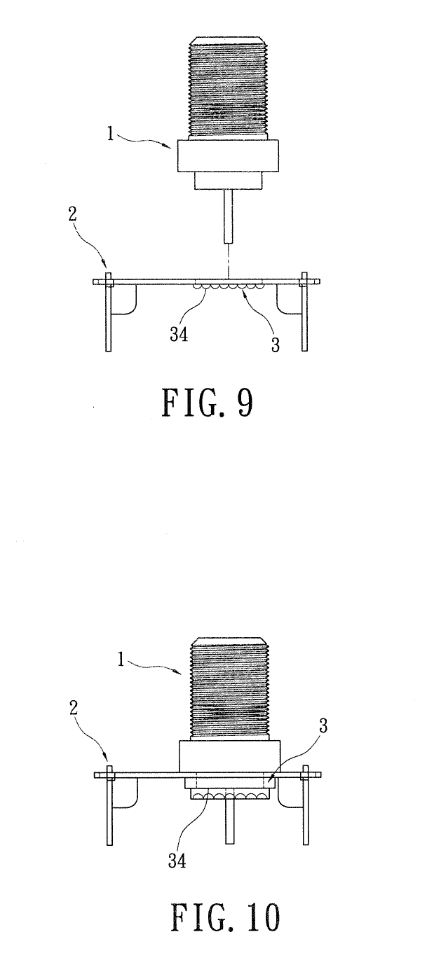

Reference is made to FIGS. 9 and 10. In this embodiment, the conducting element 3 is a conducting glue 34. Before the conducting glue is used, it is liquid, semi-solid, gel, or cream. The conducting glue 34 is a conductive metal or material, and uses the liquid, semi-solid, gel, or cream material as the raw material. By using a glue-spotting tool, the semi-solid conductive material is coated or pasted onto the contact area of the communication connector 1 or the frame 2, such as on the inner side (as shown in FIGS. 9 and 10), the outer side of the frame 2, or on the communication 1.

Next, the communication connector 1 and the frame 2 are assembled so that the conducting glue 34 is located and conducted at the connection area of the communication connector 1 and the frame 2. In this embodiment, the assembly process can be changed. After the communication connector 1 and the frame 2 are assembled, the semi-solid conductive material is coated or pasted onto the contact area of the communication connector 1 or the frame 2, such as on the inner side (as shown in FIGS. 9 and 10), the outer side of the frame 2, or on the communication 1.

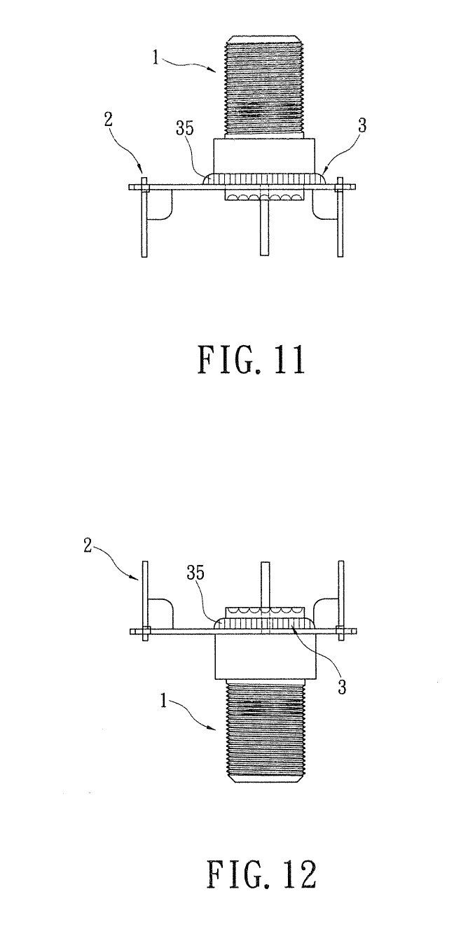

Reference is made to FIGS. 11 and 12. In this embodiment, the conducting element 3 is a formed tin ring 35. The tin ring 35 uses material such as tin-strip, tin-flake, or tin-rod with flux as the raw material and the tin ring 35 is formed with a proper shape and dimension by the winding machine, a forming tool (traditional, airing, or pressuring), a slide forming, a bending machine, or a pressing machine. It is can also be rolled manually.

The tin ring 35 is located at the connection area of the communication connector 1 and the frame 2. Furthermore, the tin ring 35 can be installed at the outer side of the frame 2 (as shown in FIG. 11), or the inner side of the frame 2 (as shown in FIG. 12). By using an oven, an electric stove, a soldering stove, or a hand-held heater to melt the tin so that the tin ring 35 is melted, located and conducted at the connection area of the communication connector 1 and the frame 2.

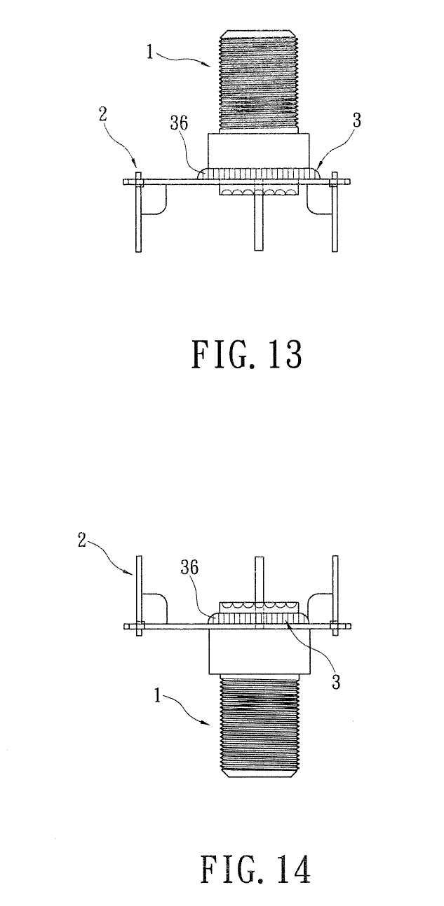

Reference is made to FIGS. 13 and 14. In this embodiment, the conducting element 3 is a tin washer 36. The tin washer 36 is also a tin ring. The tin washer 36 contains flux or is coated with flux. The tin washer 36 is formed with a tin flake that has a proper dimension by using a winding machine, a forming tool (traditional, airing, or pressuring), a slide forming machine, a bending machine, or pressing machine. It is also can be rolled manually

The tin washer 36 is located at the connection area of the communication connector 1 and the frame 2. Furthermore, the tin washer 36 can be installed at the outer side of the frame 2 (as shown in FIG. 13), or the inner side of the frame 2 (as shown in FIG. 14). By using an oven, an electric stove, a soldering stove, or a hand-held heater to melt the tin so that the tin washer 36 is melted, located and conducted at the connection area of the communication connector 1 and the frame 2.

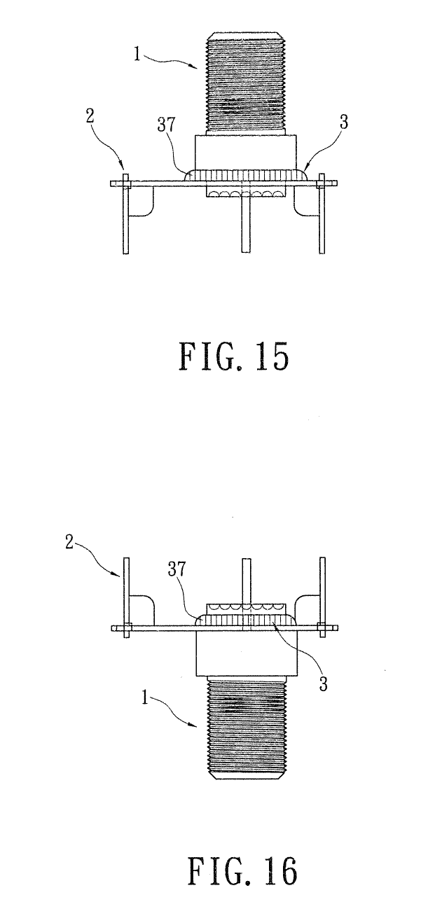

Reference is made to FIGS. 15 and 16. In this embodiment, the conducting element 3 is a tin ring 37 formed by powder metallurgy or metal injection. The raw material for the tin ring 37 is tin powder or tin ball. The tin ring 37 with a proper dimension is manufactured by powder metallurgy or metal injection.

After the tin ring 37 is coated or filled with flux, the tin ring 37 is located at the connection area of the communication connector 1 and the frame 2. Furthermore, the tin ring 37 can be installed at the outer side of the frame 2 (as shown in FIG. 15), or the inner side of the frame 2 (as shown in FIG. 16). By using an oven, an electric stove, a soldering stove, or a hand-held heater to melt the tin so that the tin ring 37 is melted, located and conducted at the connection area of the communication connector 1 and the frame 2.

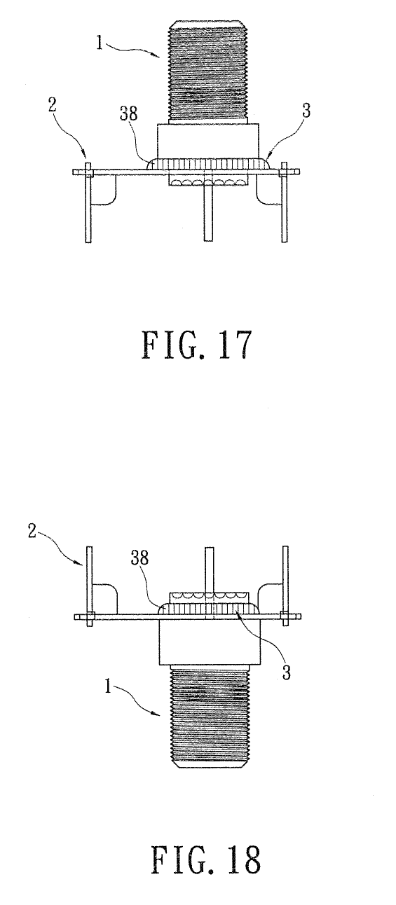

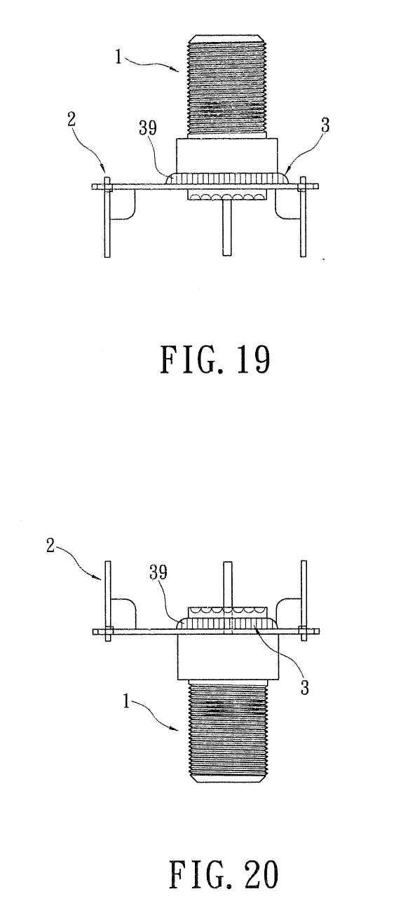

Reference is made to FIGS. 17 and 18. In this embodiment, the conducting element 3 is a tin ring 38 formed by die-casting or heat-casting. The raw material for die-casting is tin powder, tin ball, or tin ingot. The raw material for heat-casting is tin-strip, tin-flake, or tin ingot. The tin ring 38 with a proper dimension is manufactured by working process and equipment of die-casting or heat-casting.

Specifically, as shown in FIG. 22A and 22B, a tuner structure 7 further comprise a communication connector 79 and a frame 77, in which the communication connector 79 is preinstalled on the frame 77 by a fitting portion 78. The fitting portion 78 is located at lower end of the communication connector 79, which might have several kinds of configurations, such as triangle column, quadrilateral column, hexagon column, etc. In this embodiment, the fitting portion 78 comprises an upper fitting 78A and a lower fitting 78B. The frame 77 has a first contact face 71, a second contact face 72, a mounting through hole 76 on the frame 77, and a side wall joining the first contact face 71 and the second contact face 72.

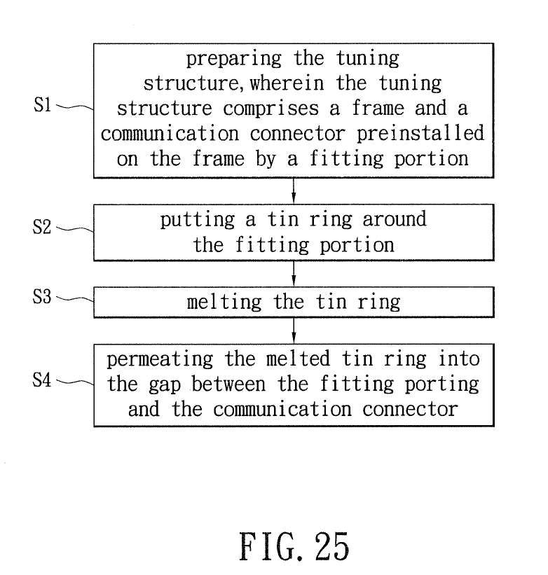

A favorable embodiment as shown in FIG. 22B, the mounting through hole 76 is on the frame 77; additionally, the first contact face 71 and the second contact face 72 are opposite and parallel to each other. The first contact face 71 and the second contact face 72 are upper surface and lower surface of the frame 77 respectively. Please simultaneously refer to the flow chart of the FIG. 25, in order to improve voltage difference of the tuner structure 7, the soldering method of the tuner structure 7 comprises Step Si: preparing the tuner structure 7, wherein the fitting portion 78 is already preinstalled into the mounting through hole 76, and contacted on the first contact face 71; namely, the lower fitting 78B is disposed through the mounting through hole 76, so that the upper fitting 78A is placed on and contact the first contact face 71; in short, the communication connector 79 and the frame 77 is combined into the tuner structure 7. Specifically, the fitting portion 78 coupled with the frame 77 may be by means of tightly fitting and an afterward staking or punch process, making fitting portion 78B expanded slightly but locked in mounting through hole 76 firmly. Meanwhile, the tin ring 38 is not yet applied on the assembled communication connector 79 and frame 77

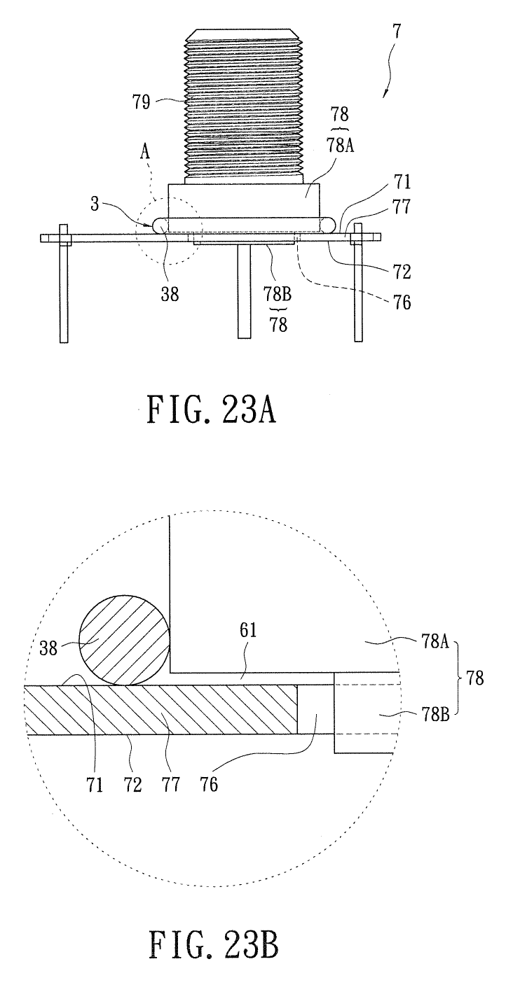

As shown in FIG. 23A, putting a tin ring 38 around the fitting portion 78 is proceeded (Step S2). In this manner, the tin ring 38 is put on the first contact face 71 and surrounds the upper fitting 78A. Afterward, the tin ring 38 is therefore disposed in proximity of the frame 77 and the fitting portion 78.

As shown in FIG. 23B which is enlarged diagram of FIG. 23A. Although the communication connector 79 is coupled with the side wall of the frame 77, a gap 61 might always exist between the upper fitting 78A and the side wall. The gap 61 could be extremely tiny, but sufficient to result in voltage difference; the voltage difference brings down data quality and quantity during transmission. Similarly, the side wall of the frame 77 normally contacts the lower fitting 78B, but inevitably cannot completely contact the lower fitting 78B, hence there should be some tiny gap existed between the mounting through hole 76 and fitting portion 78B. In order to clearly illustrate the gap, this tiny gap between frame 77 and fitting portion 78 on FIG. 23B has been exaggeratedly enlarged for the purpose of illustration.

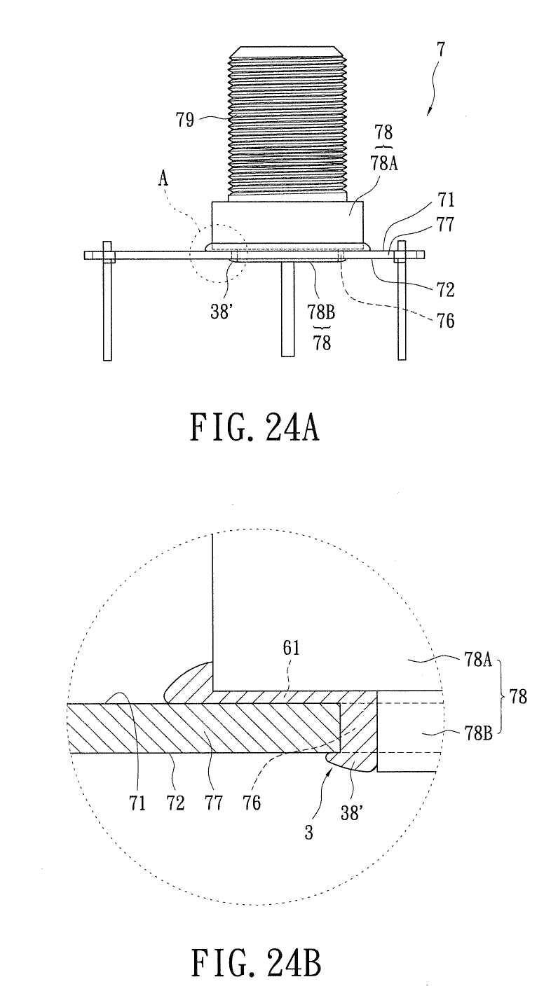

In the purpose of improving voltage difference, as shown in FIG. 24A-24B, the tin ring 38 is melted to fill up the gap 61 between the fitting portion 78 and the side wall of the frame 77 as well as the mounting hole 76 (Step S3), so that permeating the melted tin ring 38′ into the gap 61 between the fitting porting 78 (as well as the mounting hole 76) and the communication connector 79 (Step S4) is proceeded. Therefore the melted tin ring 38′ touches the fitting portion 78 and the side wall (even including face 71 and 72). In this manner, the space (including gap 61) between the frame 77 and the communication connector 79 is totally eliminated, and the voltage difference between the frame 77 and the communication connector 79 is thus improved due to the increased connecting area.

In previous embodiment, the tin ring 38 is a complete circle; however, in some other embodiment, the tin ring could also be an incomplete circle such as half circle, quarter circle or even an arc configuration. Moreover, the tin ring 38 can be located on either inner side or outer side of frame 77 before the tin ring 38 is melted.

The present invention has the following characteristics:

1. The tuner structure for improving the voltage difference of the present invention is not implemented by the manual soldering way so as to increase the conductivity of the communication connector and the frame to improve the voltage difference. The manufacturing time and cost are reduced.

2. The tuner structure for improving the voltage difference of the present invention can be applied to a variety of communication connectors (socket), such as an F connector manufactured by turning or free-cutting, a PAL connector manufactured by turning, free-cutting, pipe-cutting, or deep-drawing, or other connector. The voltage difference is improved.

The descriptions above only illustrate specific embodiments and examples of the present invention. The present invention should therefore cover various modifications and variations made to the herein-described structure and operations of the present invention, provided they fall within the scope of the present invention as defined in the following appended claims.

1. A tuner structure soldering method for improving voltage difference, comprising:
preparing the tuner structure, wherein the tuner structure comprises a frame and a communication connector with a fitting portion preinstalled on the frame;
putting a tin ring around the fitting portion;
melting the tin ring and permeating the melted tin ring through the gap between the fitting porting and the frame.

2. The tuner structure soldering method of claim 1, wherein the tin ring is a complete circle or an incomplete circle.

3. The tuner structure soldering method of claim 1, wherein the tin ring is located on the inner side or outer side of frame before melting the tin ring.
